(19) United States
(12) Patent Application Publication
(10) Pub. No.: US 2005/0044511 A1
(43) Pub. Date: Feb. 24, 2005

(54) Method and apparatus to simulate an outdoor window for a windowless room

(75) Inventor: Chiou-muh Jong, Ellicott City, MD (US)

Correspondence Address: CHIOU-MUH JONG, 11058 DORCH FARM ROAD, ELLICOTT CITY, MD, 21042, US

(73) Assignee: Chiou-muh Jong, Ellicott City, MD (US)

(21) Appl. No.: 10/604,709

(22) Filed: Aug. 12, 2003

(51) Int. Cl. G09G 5/00

(52) U.S. Cl. 715/865; 715/747; 715/757

(57) ABSTRACT

A method and apparatus to simulate an outdoor scene visible window for a windowless room. The apparatus has a preferably flat display monitor which can be mounted on the wall in a windowless room. When the simulation is in operation, it displays, in addition to the real-time outdoor scene, the image of a curtain, a blind, a shade or the like with an openness and position can be controlled by the user to simulate the look of a real window with outdoor scene through glasses. The apparatus not only can be used to display real-time outdoor scene, but also can be used to display other video images and serves as a decoration item for a windowless room.

### BACKGROUND OF INVENTION

1. Field of the Invention

The present invention relates to the simulation of an outdoor window for a room without real window. It relates to the application of a surveillance system.

2. Background

Recent advances in display monitor technologies such as LCD and plasma displays have been obvious. It is easy to notice that the screens for televisions and personal computers have gradually become flat and getting bigger in size. In fact, they are not only getting bigger in display size, but also weighing lighter and getting more affordable in the commercial market. As the advance of such display technology is going on, the big, flat and light in weight display screens will have more interesting applications. For example, one ideal application for these big, flat display monitors is to use them to simulate the outdoor window for a windowless room. Anybody who works in a commercial office building knows that rooms with windows to see outdoor scene are always in great demand, and such outdoor scene accessible rooms usually are only assigned to those employees who hold higher positions.

In the mean time, the surveillance systems for monitoring specific locations are getting more popularity. Such system often equipped with at least a wireless video camera to obtain the dynamic image sequence from the surveyed locations. With the maturity of such kind technology, it is natural and of no difficulty to add function which will interactively create the image of window covering such as mini-blind according to user's input and superimpose the created image into the images displaying in such surveillance system, resulted to a simulated window system which looks like a real window with curtain and outdoor scene on display. Alternatively, we can mount the screen of the surveillance system on the wall in a windowless room, install the video camera at a outdoor location then put a real curtain or mini-blinds on the top of the display screen to have one form of the simulation of outdoor window with real curtain. However, there will be no plurality of types and styles of the curtains in such arrangement and sometimes it is not easy to install particular style of curtains, blinds or the shades, and once installed, it is difficult to replace to another one. Cost of window coverings is another factor for not to simulate with real curtains, since some curtains or shades may cost as much as the display screen, not to mention that there still a need for a control mechanism to automate the real curtain or an user input device to link the display and motion of the curtain position.

While the commercial surveillance systems are used for monitoring scenes of interest for security or other reasons, most emphasis in designing such systems is in the motion detection from the clues reveal in the image sequence. The purpose of present invention, on the other hand, is to provide dynamic view of interested outdoor locations using display monitors with operable curtain image which looks similar to an outdoor scene accessible window with real curtain. It is fair to say that, in addition to it's functional value, the present invention also has great decoration value by mounting a beautiful simulated window on the wall.

One feature of present invention is that the monitor mounted on the wall can also be used as computer monitor or as other display device, provided that the monitor has imbedded a selection switch to select to select from at least two modes of applications, one for simulation and another for TV or computer monitor. Multi-purpose monitors has become easier to implement because the increasing popularity of digital TV programs which are displayed in either plasma or LCD monitors-both accept digital signals just like computer monitors. There is no question that the trend in the near future is to use digital signals for better video quality. We have already seen this happens in TV cellular phone industries.

Recent development in Wireless technology such as Bluetooth has made wireless applications very convenient to implement. By using such technology in receiving the outdoor images, the resulted window simulation system will be portable to mount on any wall where power is available. Bluetooth can also be applied to the wireless communication between wall mounted monitor and computer such that operations on desktop keyboard/mouse can remotely control the display on the monitor.

There is no question that one who is familiar with the art of developing computer software for creating images can design software dedicated to creating the instant simulation images. But one should know that when the display screen is mounted on the wall as a requirement in present invention, it is difficult to hide the connection cable between computer and display monitor, so a wireless communication between them would be assumed. Therefore, an extra cost already exist by using computer to process the simulation images. In fact, a stand alone embodiment of present invention offers many more advantages over embodiment that uses computer power and memory to achieve the simulation. First, not every windowless room has a computer. Standalone design make it portable to every windowless room. Second, the simulation process in present invention does not need as much computing power and storage memory as a typical personal computer, so it is good to have simpler CPU and memory to independently process the images. Personal computers usually take more than 30 seconds to boot up. It would be too tedious if one needs to start a computer before starting the window simulation every time unless the computer stays in running mode all day long. Third, using computer keyboard/mouse to move curtain up and down does not offer as good in simulation fidelity as using the user interface devices installed directly around the rim of the display screen.

### SUMMARY OF INVENTION

A method and apparatus to simulate an outdoor window for a windowless room is provided. According to one aspect of present invention, users of one embodiment of this invention will be able to see the outdoor scene in a windowless room with the choice of their favorite window coverings simulated on the screen, manipulate the simulated window coverings at their desired openings and positions. As such, the resulted embodiment of this invention is not only useful as a tool for displaying desired outdoor scene for a windowless room, but also a good decoration item for such room to install.

### BRIEF DESCRIPTION OF DRAWINGS

FIG. 1 shows how a typical commercial surveillance system relates to present invention in form of block diagram. The dashed-line parts in the drawing are the component and function added to a commercial surveillance system for an embodiment of an outdoor window simulation system.

FIG. 2 Shows an embodiment of an outdoor window simulation system with an half opened, mid-positioned mini-blind in display.

FIG. 3 is a block diagram showing the steps in creating instant simulation images.

### DETAILED DESCRIPTION

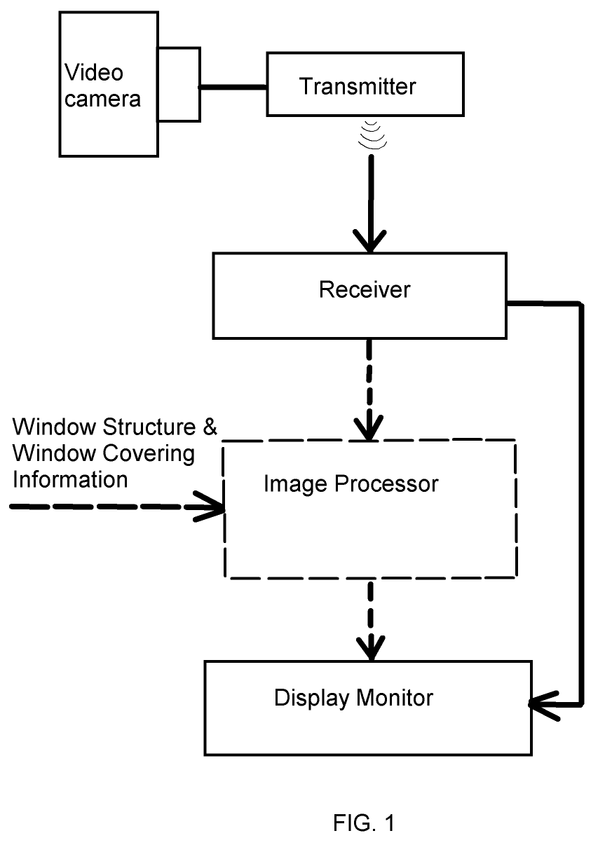

In a simple surveillance system, as shown in FIG. 1, at least one video camera is used to take the pictures from desired locations and transmit the pictures at a fixed rate through wire or broadcast wirelessly through a transmitter to a receiver or multiplexer. The pictures may be processed in the multiplexer before being sent to one or more display monitors. A multiplexer accepts multiple inputs through different channels at the same time, manipulate the these inputs into desired video signals and output signals through multiple channels to monitors at different locations. Present invention takes wired or wireless camera input, but one input at a time and no need to send to multiple displays, so the conventional multiplexer is not needed in present invention.

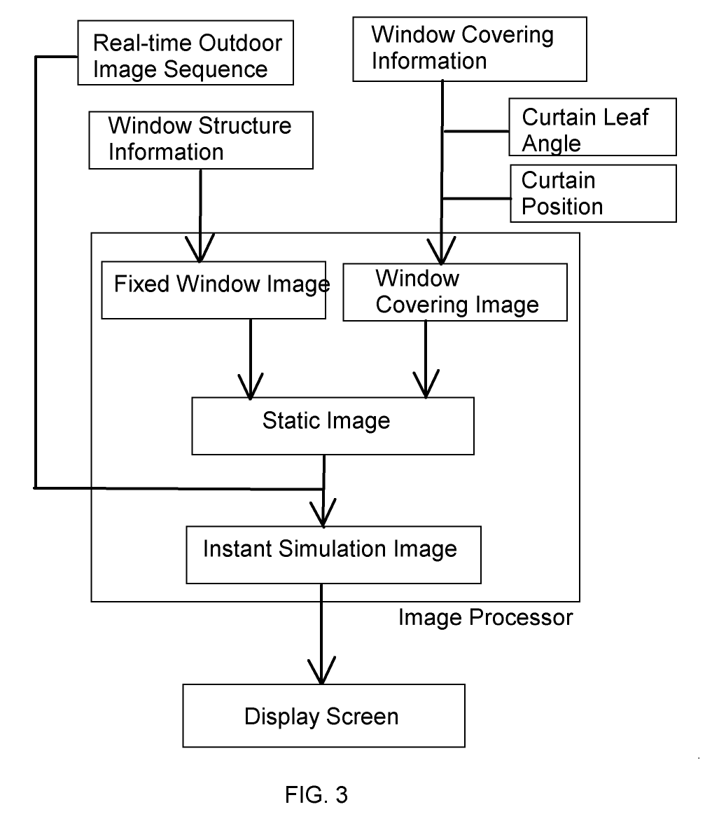

The dashed-line arrow and dash-line block in FIG. 1 show the major parts in present invention which do not exist in a commercial single input single output surveillance system. We see that an image processor, represented by the dashed-line block, receives signals from a receiver as well as from memory designated to store window structures and window coverings information, as represented by the dashed-line arrow, is used to create instant simulation images. As shown more details in FIG. 3, the image processor creates fixed window image based on the user's choice of type of window structure and then creates a window covering image based on user's choices of type, style and color and current settings of openness and position of the window covering before combining them into a static image. This image is static in the sense that it will stay the same until user inputs new openness or new position through interface devices and consequently forces the image processor to redraw the static image. The image processor further combines the static image with current available image from the receiver into instant simulation image and sends to the display monitor at a typical display rate of 30 frames per second.

If the fixed window image and window covering image are considered as coming from two separated channels, then the image processor can be viewed as a special purpose three input one output multiplexer. While the function of a typical multiplexer is to combine the images from different locations into one display, or to perform some image processing in order to extract some clues for motion detection, the function of the image processor in present invention is to overwrite portions of the outdoor image by the contents in the static image. In most applications, the multiplexer is designed and built as a stand alone device and uses wires to connect to other devices. The preferable embodiment of present invention is to install the hardware of the image processor into the display monitor for considerations of portability and fidelity of simulation.

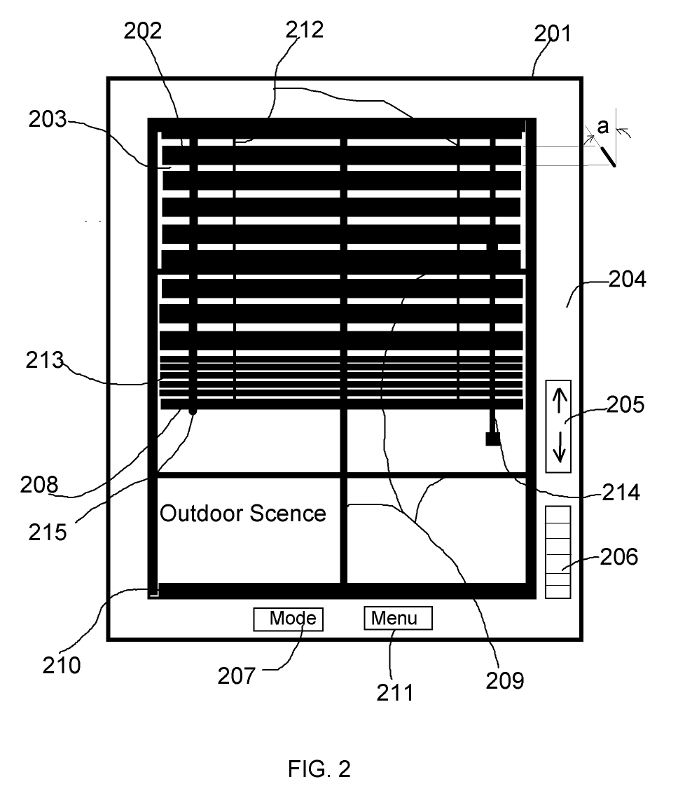

FIG. 2 Illustrates a more detailed embodiment of present invention. In this particular embodiment, an outdoor window with edges 210 at all four rims and a window grid 209 consists of three grid members for separating the window into six equal portions is shown. Also shown in FIG. 2 is the example of using mini-blind as the window covering. The mini-blind has an openness angle a with respect to the vertical line shown in the drawing at the first leaf 202. The gap 203 between two leafs disappears when user adjusts the openness angle a of all leafs to 90 degree and consequently the window portion from top to the position of the end piece 208 will be fully blinded, as a real mini-blind does to a real window. Note that unless the end piece is moved to the full extension position, some of the bottom leaves 213 will remain unexpanded and have an openness angle of 0 degree. The openness angle is adjusted through the user interface device 206, which functions like a wand tilter in a real mini-blind. The device 206 can be of any kind analog switch. Shown in the drawing is a particular embodiment using turn-wheel type switch to adjust the openness angle.

Also in FIG. 2, the display monitor 201 has an outer frame 204 which hosts another user interface devices 205. Interface device 205 is an increment-decrement type of analog input device, functions like a lifting cord in a real mini-blind, for the user to move the position of end piece 208 of the mini-blind up and down. This interface device is universally useful to all types, styles of window coverings. For the case of a vertical blind, the position of the blind is characterized by the side piece if the operation is to move all the leafs sideward, or by the center piece of the blind if the operation is to split in the center by moving half of the leaves leftward and another half rightward.

The Mode switch 207 is used to set the application mode to be simulation mode, TV mode if the monitor itself is a television set, normal display mode as computer monitor or as other video display application.

It is obvious that, for the outdoor window simulation system to be more portable, the receiver, the memory storage for window structure and window covering information, and image processor are preferred to be imbedded inside the display monitor. The memory storage in particular, can be merged with the memory in monitor such that the display for selection of a particular window structure and window covering type, style, and color is integrated with the menu built in the monitor. The selections user makes in this setup stage are stored as default values and will be used when the power is on, staying the same until user change them. User should also be allowed to change the window structure and window covering settings at run-time during the instant simulation image is on display. The interface device 211 is used to serve for this purpose. Functionally, when the pushbutton device as an example of device 211 is pushed, a small popup will display all possible choices for the user. A touch-screen control will be appropriate in this case for user to select and highlight the desired item. Another push on the button will terminate the selection process and resume the instant simulation image with new selection of window covering or new look of the window structure.

The remote control device used for a television set is another place to imbed all the user interfaces and controls for simulation. One embodiment of present invention is to use a television set as the display monitor, the remote controller is usually available for the TV set and can be reprogrammed such that the setup menu also include the selection of window structures and selection of window covering types, styles and colors, provided that the necessary memory storage and control circuit have also installed and integrated with other circuit inside the TV set.

In the process of creating instant simulation image, any pixel location where it does not belong to window edges, window grid and window covering, should get it's pixel value from outdoor image. The gap 203 in FIG. 2, for example, should reveal a small portion of the outdoor image, otherwise the simulation will not look real and thus loses some fidelity.

The static image is a combination of fixed window image and the window covering image. Fixed window image is relatively simple since the image will not change through the all display time, so the whole image can be preconstructed and stored in the memory waiting for retrieval. Some windows installed in the big building are not operable, have no edges, no window grids at all. Smaller operable window typically has upper and bottom halves, and each half has several grid members to separate it into 2, 4, 6 or 9 equal regions. In fact, the window structure is simple enough to be constructed by using only some parameters which represent the location coordinates of vertices of all edges, location coordinates of grid members, and their colors to reconstruct the fixed window images.

By comparison, the window covering image is much more involved. A shade, for example, is a piece of cloth or other material folded to have many wavy pleats and sandwiched by a top piece and an end piece wood like strips. There is no leaves, so there is no leave angle to adjust. It shelters the window from the top to the end piece and the only adjustment user can manipulate is it's position. This is an example of window covering with only one degree of freedom. In order to reconstruct the image of a shade extended to a particular position, one can digitize the entire stroke of the position of the end piece into N steps. N should be large enough so that when end piece is moved from position i to i+1, where i+1<=N, the transition in image change should look as smooth as possible. The pleats will be stretched flatter when the end piece is moved to extend the shade, so every position i corresponds to a width w of all pleats. Because all pleats are of same size w, a total of n such size pleats connected together plus top and end pieces represent the completed shade being extended to position i. The entire shade is hold together in place by two thin ropes 212. To reconstruct the image for the entire shade extended to position i, all we need is the graphics of top and end pieces, the graphic of a pleat with width w. In other words, if in the memory we have stored graphics of top and end pieces and graphics of N pleats of distinct widths, we can reconstruct shade images for all N positions. When a user moves the increment/decrement input device starting at shade position i and finally stopping at position j, the image processor will retrieve the graphic for the pleat at each intermediate position and copy it to get a total of n pleats of the same size, combines them with top and end pieces to form a intermediate shade image, and continue to process the same way until the shade image at position j is reached. For better simulation fidelity, each graphic can have 3-D or animation effect. Each graphic of the pleat should also include small sections of the two thin ropes such that, when n graphics of the same pleats are combined together, the two thin ropes will look like extending from top piece to end piece without interruptions.

For other type window coverings with two degrees of freedom, such as a mini-blind, has both openness and position to adjust, the modeling situation is different. The operation of a mini-blind is characterized by changing the leaves openness angle using a wand tilter and by expanding a number of leaves from it's total amount using the lift cord. Therefore, in this particular embodiment, N graphics of the leaves representing N openness angles are stored, along with graphics of the top and end pieces and other necessary information such as color of leaves. To reconstruct the image of a mini-blind at an openness angle a and an extended position p with the understanding that position p corresponds to m expanded and n−m unexpanded leaves of total number n, the image process will retrieve the graphic of leaf corresponding to openness angle a, duplicates it m−1 times to make m graphics of openness angle a, then combines them together to form the expanded portion of the mini-blind image. Image processor will also retrieve the graphic of leaf corresponding to openness angle of zero degree, duplicates n−m−1 times, combines them together to form the unexpanded portion of the mini-blind image. Top piece and end piece are then added to complete the entire mini-blind image. During the combination of m leaves for the expanded portion of the blind image, a gap of amount g which depends on the openness angle will be added between blind leaves and the pixel values of these gaps will be replaced later by pixel values from same locations in the outdoor image when the instant simulation image is reconstructed. The image reconstruction process will be repeated every time when the user operates the interface 205 to move blind up and down or interface 206 to change the leaves openness of the blind.

Alternatively, if the memory size is big enough, one can use a digital camera, take the pictures of a real shade extended at N different positions, manually edits all pixels not belong to the shade with a special pixel value uniformly and then store them as shade image templates for retrieval. When a static image is required, the image processor retrieves fixed window image and the shade image template corresponding to desired position, combines them together, with the understanding that whenever a pixel is overlapped from both images, the shade image pixel will be used as new pixel value. In such way, the static image for desired window structure and shade can be created. In creating instant simulation image we note that all the pixels in static image with uniform special value will be replaced by pixel values of the outdoor image at same locations. So for window coverings of one degree of freedom, we can reconstruct the static image in similar way. For two degrees of freedom window coverings such as a vertical blind, it is difficult to store all images for every digitized openness angle and every digitized position, because if 100 positions and 90 angles are used, there will be 9,000 images to be stored and roughly 9 gigabyte memory is needed even if the resolution of each image is as low as 1 megapixels. It will then be possible for this embodiment without a big storage memory if a suitable image compression method is available without losing too much of the image quality when used. Otherwise, a scheme to reduce the number of images stored is necessary. Actually, one needs only to store the images for all digitized openness angles as image templates and then reconstruct the images for all positions based on these templates. Every image template is a digital picture taken at a specific openness angle, preferably with only one leaf expanded and the rest unexpanded. When a vertical-blind image of desired position and specific openness angle is needed, the template corresponding to desired angle is retrieved. Based on the desired position, some number of expanded leaves will be and the same amount of the unexpanded leaves will be reduced to match the desired position. Unfortunately, this way of reconstructing image for window covering of two degrees of freedom does not improve much as compared to the total reconstruction method mentioned in previous paragraph. If the memory size not a problem and good image compression scheme is available, it is a better implementation to store images for all digitized positions and all digitized openness angles for retrieval.

The size of display monitor for present invention depends on the size of the room to install the system, but there is no strict rule to follow. Currently, the largest commercially available size for plasma monitors such as NEC PlasmaSync 61MP by NEC Corporation of Japan is 61″ diagonally and has aspect ratio of 16:9, which is roughly 53″×30″ in length by width. With such size display monitor, it should be big enough for most windowless room to display a simulated outdoor scene with operable artificial curtain. Largest size for commercially available LCD monitors is 40″ diagonally, also by NEC with model name LCD4000, translates into 34″×20″, is bigger than many small real windows, therefore should be big enough for many small rooms. For the purpose of application in present invention, the sizes of available monitors is thus not a problem. The thickness of the monitors are thinner than 4″ for largest plasma monitor, which is thin enough to look like a real window mounting on the wall. The weight of monitor, around 150 pounds for largest plasma monitor, is light enough not to cause too much trouble mounting on the wall. The only concern is the price of big size display monitors. However, as happened to all other electronic products, the price will drop sharply as the popularity of digital TV increases to some point.

The frame 204 in FIG. 2 can be framed with a wood molding for better look and more similar to a real window. Normally, a mini-blind equips with a lift cord 214 for moving the end piece up and down. Since we already have device 205 functions as generic lift cord for all window coverings, item 214 is in the display just for higher simulation fidelity. Similarly, The wand tilter 215 is in the display for the same purpose since it's function has been implemented by device 206.

Although the invention has been illustrated with some particular embodiments, variations and modifications within the scope of the invention are very possible. Fidelity of simulation will also vary with the graphics of the window coverings. Whatever the variation is, it will achieve the goal of present invention—a method and apparatus to simulate an outdoor scene visible window for a windowless room, with a plurality of different types, different styles and different colors of operable simulated window coverings to choose from. In addition, the display monitor can be used for other purpose such as displaying DVD movies. Present invention is not only a multi-purpose device, but also a good decoration item for a windowless room. Hopefully, some employees work in big building will prefer windowless room equipped with outdoor window simulation system by present invention which offers many variations of window coverings and different views decided by location of video cameras over the room with real outdoor window because real window equipped with fixed style window covering and can only see the view immediate outside the window.

1. A method to simulate an outdoor scene visible window for a windowless room comprising:
receiving a sequence of outdoor images from a source;
creating a window covering image which is a simulation of a window covering at a certain openness and position of user's preferences;
creating a fixed window image which is a simulation of a real window with window structure includes window edges and window grid;
superimposing said curtain image on said fixed window image to form a static image;
combining current frame of said outdoor images with said static image to form an instant simulation image, said instant simulation image is a simulation of the look of a real window with said window covering opened at a certain position and a openness of user's preferences;
updating said instant simulation image at a frequency of designer's choice;
updating said instant simulation image when either said openness or said position of said window covering image is changed; and
displaying said instant simulation image.

2. The window covering in claim 1 include shades, blinds, different styles of curtains, valance and drape combinations and window panels;

3. A memory storage to store information about various window coverings and window structure described in claim 1 in terms of parameter values.

4. A video signal receiver for receiving the sequence of outdoor images described in claim 1;
said sequence of outdoor images comes from sources include transmitted signal by the wire from an outdoor video camera, the broadcast signal from wireless video cameras through video transmitters, and wired or wireless signal from a computer wherein said sequence of outdoor images is available through any means;

5. an image processor for creating the instant simulation image described in claim 1.

6. Means to retrieve the information from a memory storage described in claim 3 for displaying a plurality of types, styles and colors of said window coverings and a plurality of types of said window structures in a table, wherein a preferred type, style, color of said window covering and said window structure can be chosen.

7. An user interface device, coupled to the image processor of claim 5, interactively causes said image processor to draw new said instant simulation image wherein reflects new position of the simulated window covering changed by the user.

8. An user interface device, coupled to the image processor of claim 5, interactively causes said image processor to draw new said instant simulation image wherein reflects new openness of the simulated window covering changed by the user.

9. A display monitor, preferably flat in viewing surface and mountable on the wall, for dynamically displaying the instant simulation image in claim 1.

10. The display monitor described in claim 9 includes monitor equipped with control circuit to receive and display television programs.

11. The display monitor described in claim 9 includes monitor equipped with computer hardware and control circuit capable of carrying out instruction set operations.

12. The image processor described in the claim 5 includes an independent CPU/Memory combination and a subset of CPU/Memory in a computer with required software to achieve the function of creating said instant simulation image.

13. The parameter values in claim 3 comprising:
enumerated values of types, styles and colors of said window coverings;
enumerated values of types of said window structures; and
design parameters include number of leaves, size of leaves and aspect ratio of said window coverings which are predetermined for matching the size of display screen.

14. An outdoor window simulation system for carrying-out the method to simulate an outdoor scene visible window for a windowless room comprising:
a memory storage to store information about various types window structures, various types, styles and colors of window coverings.
an I/O interface displaying a table of information about available choices of type window structures and types, styles and colors of window coverings;
a video signal receiver to receive image sequence of outdoor scene;
an image processing unit to create the instant simulation image;
a display unit mountable on the wall and preferably flat in viewing surface for displaying instant simulation image;
a device controller for adjusting the openness of the simulated window covering on the screen and sending a image redraw request to said image processing unit for updating the instant simulation image;
a device controller for adjusting the position of the window covering on the screen and sending a image redraw request to said image processing unit for updating the instant simulation image; and
a switch device coupled to said display monitor for choosing application mode from available modes of applications;

15. An outdoor window simulation system according to claim 14, wherein the available modes of application include:
a simulation mode for the application of displaying instant simulation image; and
at least one more mode of application for displaying non-simulation related application such as TV programs, computer output and other video images.

16. An outdoor window simulation system according to claim 14, wherein said display monitor includes monitor equipped with control circuit to receive and display television programs.

17. An outdoor window simulation system according to claim 14, herein said display unit includes multiple display devices combined to function together as a system.
